(19) United States
(12) Patent Application Publication
(10) Pub. No.: US 2025/0208361 A1
(43) Pub. Date: Jun. 26, 2025

(54) OPTICAL CONNECTOR MODULE AND OPTICAL WIRE MODULE INCLUDING SAME

(71) Applicant: FEMTORY CO., LTD., Gyeonggi-do (KR)

(72) Inventor: Seunghun LEE, Gyeonggi-do (KR)

(73) Assignee: FEMTORY CO., LTD., Gyeonggi-do (KR)

(21) Appl. No.: 18/851,043

(22) PCT Filed: Mar. 29, 2022
(86) PCT No.: PCT/KR2022/004457

§ 371 Date: Sep. 25, 2024

(30) Foreign Application Priority Data
Mar. 29, 2022 (KR) 10-2022-0038770

(51) Int. Cl. G02B 6/42

(52) U.S. Cl. CPC G02B 6/4228

(57) ABSTRACT

An optical connector module and an optical interconnection module comprising it are disclosed. The optical connector module and the optical interconnection module of the present invention comprise: at least one optical device configured to include at least one of a light-emitting device and a light-receiving device; and an optical fiber guide configured to contact the optical device on at least two points to align a first optical path of the optical device with a second optical path of the optical fiber at a predetermined position, wherein the second optical path acquires light generated by the optical device or transmits light to the optical device. According to the present invention, the optical device and the optical fiber can be naturally aligned with each other.

### TECHNICAL FIELD

The present invention relates to an optical connector module that enables natural mutual alignment between optical devices and optical fibers, and an optical interconnection module comprising such a connector module.

### BACKGROUND ART

When using copper wiring or copper-based cables for data transmission between devices or between internal components of a device, issues such as signal attenuation, noise generation, and lack of high-capacity/high-speed data transmission capabilities may occur

To address these issues, technologies that utilize optical signals are being developed. By using optical signals, it is possible to achieve high-speed transmission of large volumes of data, thereby solving problems that can occur with copper-based data transmission.

To transmit optical signals, optical modules based on optical components may be required. For example, this implies the need for connecting functions that link two or more optical paths while using optical phenomena such as refraction, reflection, interference, and diffraction to transmit, amplify, and merge optical signals. Optical elements that provide these functions are structured to ensure that light is transmitted with optimal efficiency.

One of the factors affecting the efficiency of optical transmission is the inherent errors in optical components. For example, errors may occur during the process of mounting optical components onto a substrate, and in the case of optical transmission materials, errors may also arise due to the eccentricity of the core.

To minimize these errors, active alignment has been proposed, where optical components are positioned at points that achieve optimal optical transmission efficiency. However, active alignment requires time-consuming processes, leading to reduced productivity. Additionally, as electronic devices become more miniaturized and are increasingly used in household applications, there is a growing emphasis on passive alignment, which consumes less time and cost for alignment. Consequently, there is a need for research into configurations and methods that can perform more effective passive alignment.

### DETAILED DESCRIPTION OF THE INVENTION

### Technical Problem

The present invention aims to solve the aforementioned problems as well as other issues. Another objective of the present invention is to provide an optical connector module that allows for natural mutual alignment between optical devices and optical fibers, as well as an optical interconnection module comprising this optical connector module

### Technical Solution

To achieve the above or other objectives, one aspect of the present invention provides an optical connector module may comprise at least one optical device including at least one of a light-emitting device and a light-receiving device; and an optical fiber guide contacting the optical device on at least two points to align a first optical path of the optical device with a second optical path of the optical fiber at a predetermined position, wherein the second optical path may acquire light generated by the optical device or transmit light to the optical device.

The optical fiber guide may include an outer surface, a coupling surface that perpendicularly penetrates the outer surface and forms a coupling hole for accommodating the optical fiber, and an inner surface extending from the coupling surface, with at least one region extending in a slanted manner so as not to be parallel to the outer surface and the coupling surface, wherein the optical fiber guide may contact the optical device on at least two points with a slanted region of the inner surface to align the first and second optical paths with each other.

The at least two points may be located at a first corner of the optical device and at another first corner symmetrical to the first one about the center of the optical device.

The optical fiber guide may further comprise a guide electrode formed on at least a portion of an inner surface that contacts the optical device, for connecting and transmitting electrical signals between the optical device and the main substrate.

The optical connector module may further include at least one solder ball positioned between the guide electrode and the optical device, wherein the at least one solder ball may be deformed by at least one of heat and pressure when the optical fiber guide contacts the optical device, to connect the guide electrode with an electrode of the optical device.

The optical connector module may further include a reinforcement plate formed on the outer surface of the optical guide corresponding to the inner surface where the guide electrode is formed, wherein the optical guide may be coupled to the main board in a direction perpendicular to the main board while the guide electrode and the reinforcement plate are soldered to the main board.

The first and second optical paths may be virtual paths formed along the center lines of the optical device and the optical fiber, representing highest light transmission efficiency between the optical device and the optical fiber.

Additionally, to achieve the above or other objectives, one aspect of the present invention provides an optical interconnection module comprising a substrate; a control device mounted on the substrate; and an optical connector module mounted on the substrate to generate or receive optical signals according to control signals from the control device, wherein the optical connector module may include at least one optical device, which comprises at least one of a light-emitting device and a light-receiving device, and an optical fiber guide that contacts the optical device on at least two points to align a first optical path of the optical device with a second optical path of an optical fiber at a predetermined position, wherein the second optical path may acquire light generated by the optical device or transmit light to the optical device.

### Effect of the Invention

The effects of the optical connector module and the optical interconnection module comprising it, according to the present invention, are as follows:

According to at least one embodiment of the present invention, there is the advantage that the optical device and the optical fiber can be naturally aligned with each other.

The additional scope of applicability of the present invention will become apparent from the detailed description provided below. However, various modifications and alterations within the spirit and scope of the present invention will be clearly understood by those skilled in the art, and specific embodiments such as the preferred embodiments described herein are to be understood as illustrative examples only

### BRIEF DESCRIPTION OF THE DRAWINGS

FIG. 1 is a drawing illustrating an optical interconnection module comprising an optical connector module according to one embodiment of the present invention.

FIG. 2 is a drawing showing the area that includes the optical connector module of FIG. 1.

FIG. 3 is a drawing illustrating various embodiments of the optical fiber guide shown in FIG. 2.

FIG. 4 is a drawing showing the optical fiber guide and the optical device as depicted in FIG. 2.

FIG. 5 is a drawing illustrating the coupling relationship between the optical fiber guide and the optical device shown in FIG. 4.

FIG. 6 is a drawing illustrating an optical connector module according to another embodiment of the present invention.

FIG. 7 is a drawing illustrating an optical device according to one embodiment of the present invention.

### BEST MODE FOR THE INVENTION

Hereinafter, the embodiments disclosed in this specification will be described in detail with reference to the accompanying drawings, wherein the same or similar components are assigned the same reference numbers regardless of the figures, and redundant explanations thereof will be omitted. The suffixes “module” and “unit” used for components in the following descriptions are assigned merely for ease of writing the specification and do not necessarily indicate distinct meanings or functions. Also, in describing the embodiments disclosed in this specification, if it is determined that a detailed description of related known technology may obscure the gist of the embodiments disclosed herein, such a detailed description will be omitted. Furthermore, the accompanying drawings are provided only for better understanding of the embodiments disclosed in this specification, and the technical idea disclosed in this specification should not be construed as being limited by the drawings. It should be understood that all modifications, equivalents, and alternatives that fall within the spirit and scope of the present invention are included.

Terms including ordinals such as “first,” “second,” and the like, may be used to describe various components, but the components are not limited by these terms. These terms are only used to distinguish one component from another.

When a component is said to be “connected to” or “coupled with” another component, it should be understood that the component can be directly connected or coupled, or there may be intervening components. In contrast, when a component is said to be “directly connected to” or “directly coupled with” another component, it should be understood that there are no intervening components.

Singular expressions include the plural unless the context clearly dictates otherwise.

In this application, terms such as “comprise” or “have” are intended to specify the presence of stated features, numbers, steps, operations, components, parts, or combinations thereof, but do not preclude the presence or addition of one or more other features, numbers, steps, operations, components, parts, or combinations thereof.

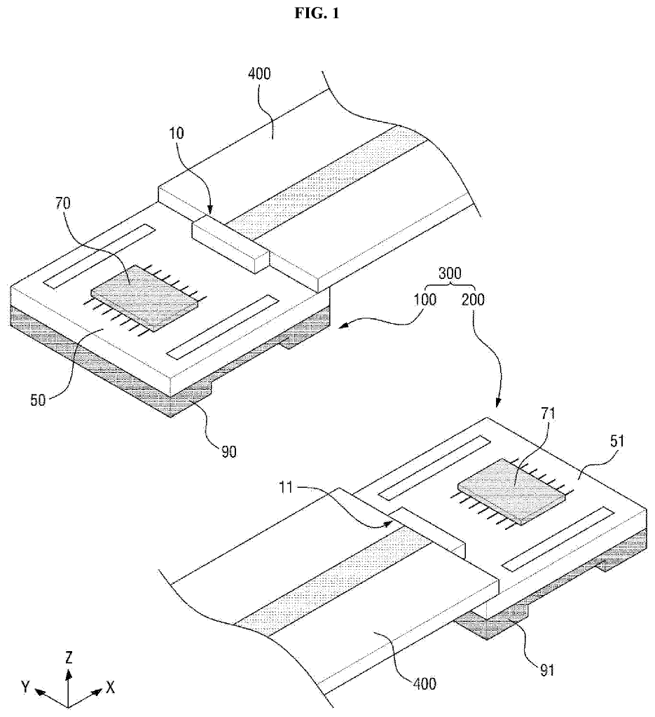

FIG. 1 is a drawing illustrating an optical interconnection module comprising an optical connector module according to one embodiment of the present invention.

As shown in FIG. 1, the optical interconnection module 300 according to one embodiment of the present invention may include a transmitting unit 100 and a receiving unit 200.

The optical interconnection module 300 can transmit and receive optical signals via a transmission cable 400. By transmitting and receiving data through optical signals, phenomena such as signal attenuation and noise can be minimized, enabling high-speed transmission of large amounts of data, such as VR and 3D video content. The optical interconnection module 300 may include a transmitting unit 100 and a receiving unit 200 connected via the transmission cable 400, which includes optical fibers.

The transmitting unit 100 may include a light-emitting control device 70 mounted on the transmitting side main substrate 50, a transmitting side electrical connector 90, and a transmitting side optical connector module 10. The receiving unit 200 may include a light-receiving control device 71 mounted on the receiving side main substrate 51, a receiving side electrical connector 91, and a receiving side optical connector module 11. The transmitting unit 100 and the receiving unit 200 have a symmetrical configuration, where one side converts electrical signals into optical signals for transmission, and the other side receives optical signals and converts them back into electrical signals. Therefore, except for separately described sections, the description of the transmitting unit 100 shall be understood as applying to the receiving unit 200 as well.

The optical connector module 10 can serve as a contact point that connects the transmission cable 400 to the main substrate 50. This means that, in the transmitting unit 100, it functions as the contact point that generates and transmits optical signals, while in the receiving unit 200, it serves as the contact point that receives transmitted optical signals.

The optical connector module 10 can directly influence the efficiency of light transmission and reception. For example, if we consider a case where light generated by the optical connector module 10 is transmitted through the transmission cable 400, the light transmission efficiency is optimized when the first optical path, which represents the path of the strongest light intensity, aligns parallel with the second optical path passing through the center of a specific optical fiber within the transmission cable 400. This alignment minimizes negative factors such as reflection, refraction, and diffraction that can affect light transmission efficiency. Conversely, if the first optical path from the generated light is not aligned with the centerline of the optical fiber (second optical path) and is tilted, it can be more clearly understood that the transmission and reception efficiency of light decreases. In other words, when the first and second optical paths are not parallel but tilted, the efficiency of light transmission and reception is reduced. To put it differently, the emission or reception surface of the optical device that generates or receives light should be positioned parallel to the end surface of the optical fiber that is near or in contact with it. Alternatively, this means that the emission or reception surface of the optical device should be optimally positioned relative to the central axis of the optical fiber. In one embodiment of the present invention, the optical connector module 10 can naturally reach a position that optimizes light transmission and reception efficiency during the assembly process.

### Mode for the Invention

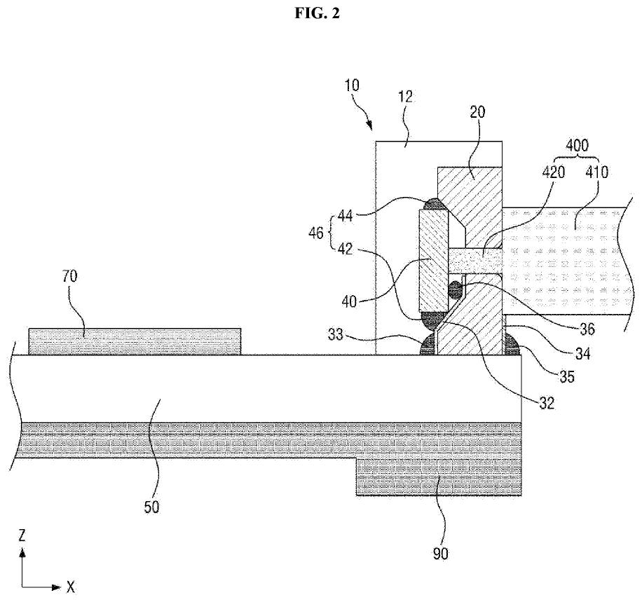

FIG. 2 is a drawing showing the area that includes the optical connector module from FIG. 1.

As shown in FIG. 2, the optical connector module 10 according to one embodiment of the present invention may include an optical device 40 and an optical fiber guide 20.

The optical device 40 may include at least one of a light-emitting device and a light-receiving device, as previously described. The optical device 40 can operate according to control signals from a control device 70. For example, when an electrical signal from the control device 70 is input, the optical device 40 can operate accordingly to generate light.

The optical device 40 may be composed of materials such as GaAs (Gallium Arsenide), InGaAs (Indium Gallium Arsenide), or InP (Indium Phosphide). The coefficient of thermal expansion of the material constituting the optical device 40 may be equal to or similar to the coefficient of thermal expansion of the optical fiber guide 20, which is in contact with the optical device 40. Therefore, even if the optical device 40 expands or contracts due to temperature changes, the alignment with the optical fiber guide 20, which is positioned to optimize the transmission or reception efficiency of the optical device 40, may not be disrupted. In other words, it can be said that the optical device 40 and the optical fiber guide 20 exhibit the same or similar amount of expansion or contraction. To put it differently, if the direction parallel to the emission or reception surface of the optical device 40 is referred to as the first direction, then the expansion or contraction amount in the first direction for both the optical device 40 and the optical fiber guide 20 is substantially identical.

The optical fiber guide 20 may be in contact with the optical device 40. The optical fiber guide 20 may contact the optical device 40 at least two points. These two points of contact between the optical fiber guide 20 and the optical device 40 may be symmetrical about the optical device 40, such as on the left and right or top and bottom. Due to the optical fiber guide 20 contacting the optical device 40 at these symmetrical points, the center of the optical fiber guide 20 can naturally align with the center of the optical device 40 during assembly. Consequently, light emitted from the center of the optical device 40 can be incident on the center of the optical fiber 420 coupled with the optical fiber guide 20, or light transmitted through the optical fiber 420 can be incident on the center of the optical device 40. In other words, this means that high transmission or reception efficiency of light can be maintained in the optical connector module 10 without the need for traditional active alignment methods, which are time-consuming and costly.

The optical fiber guide 20 can be manufactured using a MEMS (Micro Electro-Mechanical System) process. The MEMS process allows for high yield and flexibility in product design. Therefore, even if the product design changes, it is easy to produce optical fiber guides 20 that correspond to the modified design. Considering market conditions, cost competitiveness is a crucial factor for the success of the optical fiber guide 20. The production of the optical fiber guide 20 using the MEMS process can increase yield, enhance productivity, reduce material costs, and improve assembly.

When the optical fiber guide 20 is combined with the optical device 40, the optical device 40 can be electrically connected to the main substrate 50 through solder balls 36. A guide electrode 32 may be formed on the inner side of the optical fiber guide 20. Solder balls 36 may be arranged on the electrode (not shown) on the upper surface of the optical device 40. When the optical fiber guide 20 approaches for coupling with the optical device 40, the guide electrode 32 can contact the solder balls 36. The solder balls 36 can deform due to temperature and/or pressure, allowing close contact between the electrode (not shown) on the upper surface of the optical device 40 and the guide electrode 32. Once the coupling of the optical fiber guide 20 and the optical device 40 is complete, an electrical circuit can be established between the optical device 40 and the control device 70. According to one embodiment of the present invention, the use of solder balls 36, guide electrodes 32, and/or related configurations and assembly methods allows for effective circuit formation while simplifying the assembly process.

When the optical fiber guide 20 and the optical device 40 are combined, an adhesive 46 may be applied. The adhesive 46 can be applied around the optical device 40 using first and second adhesives 42 and 44. Alternatively, the first and second adhesives 42 and 44 can be connected and applied around the optical device 40. The adhesive 46 may be a high-temperature adhesive such as epoxy, liquid silicone, or urethane.

When the optical fiber guide 20 and the optical device 40 are combined, a transmission cable 400 can be attached to the optical fiber guide 20. The transmission cable 400 may include an optical fiber 420 and a sheath 410 surrounding the optical fiber 420. The optical fiber 420 may comprise a core or a core and cladding. The sheath 410 may serve to encase and protect the exterior of the optical fiber 420. According to one embodiment of the present invention, the optical fiber 420 can be coupled to a predetermined position. In other words, it is possible to attach the optical fiber 420 to the exact location without using the costly and time-consuming active alignment method. Instead, a passive alignment method, which requires less time and cost, can be used. Passive alignment can be achieved through the shape of the optical fiber guide 20 and/or its coupling relationship with the optical device 40.

When the optical fiber guide 20 and the optical device 40 are combined, fixing solder balls 33 and 35 can be used to secure the optical fiber guide 20 to the main substrate 50. The fixing solder balls 33 and 35 can be located on either side of the optical fiber guide 20 in the coupling direction of the transmission cable 400. For instance, this may imply that the first and second fixing solder balls 33 and 35, which are positioned opposite each other, can be coupled.

The first fixing solder ball 33 can be coupled to the guide electrode 32. Therefore, it can simultaneously serve to connect the guide electrode 32 with the electrode of the main substrate 50 (not shown).

The second fixing solder ball 35 can be coupled to the reinforcement plate 34. The reinforcement plate 34 can be attached to the outer side of the optical fiber guide 20 to enhance the rigidity of the optical fiber guide 20.

The stability of the optical connector module 10, which includes the optical fiber guide 20, can be ensured through the use of the first and second fixing solder balls 33 and 35. In one embodiment of the present invention, in a butt coupling method, if the optical fiber guide 20 is coupled perpendicularly to the plane of the main substrate 50, the transmission cable 400 is coupled in the plane direction of the main substrate 50. When the transmission cable 400 is connected, force is applied in the X or −X direction, which is the plane direction of the main substrate 50. If the coupling of the optical fiber guide 20 is weak, misalignment may occur. According to one embodiment of the present invention, the optical connector module 10, which includes the optical fiber guide 20, is stably coupled to the main substrate 50 through the first and second fixing solder balls 33 and 35, preventing misalignment situations in advance.

When the optical fiber guide 20 and the optical device 40 are combined, a protective member 12 can be applied. The application of the protective member 12 can prevent contamination of the optical connector module 10 and enhance its strength.

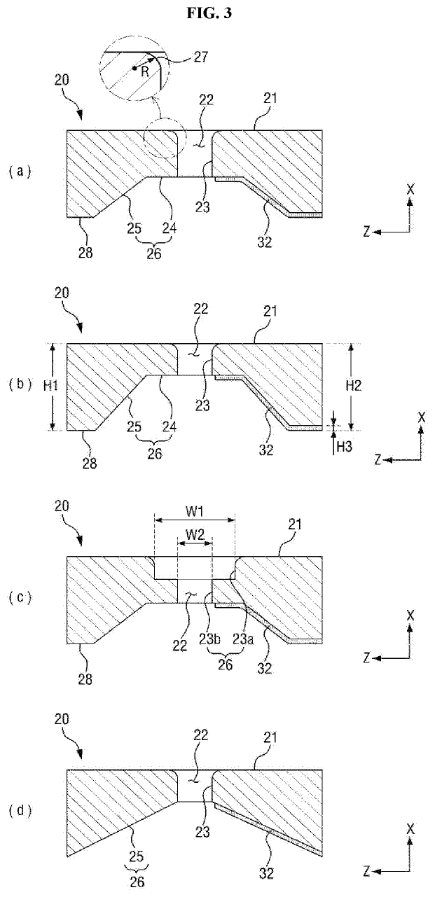

FIG. 3 is a drawing illustrating various embodiments of the optical fiber guide shown in FIG. 2.

As shown in FIG. 3, the optical fiber guide 20 according to one embodiment of the present invention can be modified into various forms.

As shown in FIG. 3(a), the optical fiber guide 20 may include an outer surface 21, a coupling surface 23 that perpendicularly penetrates the outer surface 21 to form a coupling hole 22 for accommodating the optical fiber, an inner surface 26 with at least one region extending in a slanted form, and a bottom surface 28 extending from the inner surface 26.

The optical fiber guide 20 can be formed through a MEMS process. This allows the optical fiber guide 20 to be produced with high productivity, ensuring cost competitiveness. The optical fiber guide 20 can be formed using silicon wafers through anisotropic etching, deep reactive ion etching (Deep RIE), and similar techniques.

The outer surface 21 may be flat. A coupling hole 22 may be formed at the center of the outer surface 21. A curved surface 27 may be formed between the coupling surface 23 of the coupling hole 22 and the outer surface 21. The curved surface 27 may have a constant radius of curvature (R), making it easier to insert the optical fiber into the coupling hole 22. The curved surface 27 can be formed through an etching process.

The coupling hole 22 can penetrate the optical fiber guide 20 in the thickness direction. The coupling hole 22 can be formed using a dry etching process.

The inner surface 26 may have at least one slanted region. For example, it may include a flat surface 24 that extends substantially parallel to the outer surface 21 from the end of the coupling surface 23, and an inclined surface 25 that extends from the flat surface 24 in a slanted form so as not to be parallel to the outer surface 21 and the coupling surface 23.

The inclined surface 25 can be symmetrically formed on the inner surface 26 of the optical fiber guide 20. In other words, this means that the inclined surface 25 can be formed at the same angle of inclination about the centerline of the coupling hole 22 in its lengthwise direction.

At least a portion of the inner surface 26 may have a guide electrode 32 formed on it. The guide electrode 32 formed on a portion of the inner surface 26 may extend down to the bottom surface 28.

Due to the presence of the guide electrode 32 on a portion of the inner surface 26, the thickness of the guide electrode 32 may cause a height difference between the part of the inclined surface 25 with the guide electrode 32 and the part without it. In such cases, when guided by the inclined surface 25 and coupled with the optical device (40 in FIG. 2), the coupling hole 22 may be positioned slightly tilted relative to the upper surface of the optical device (40 in FIG. 2). Therefore, the end face of the optical fiber (420 in FIG. 2) inserted into the coupling hole 22 may also be positioned slightly tilted relative to the upper surface of the optical device (40 in FIG. 2). When the end face of the optical fiber (420 in FIG. 2) is positioned slightly tilted relative to the upper surface of the optical device (40 in FIG. 2), the likelihood of total internal reflection occurring between the optical fiber (420 in FIG. 2) and the optical device (40 in FIG. 2) can be reduced. For instance, if the optical fiber 420 is adjacent to the upper surface of the optical device 40 and the end face of the optical fiber is finished to a mirror surface quality, perfect alignment of the end faces can actually cause total internal reflection. Therefore, by slightly tilting the end faces relative to each other, the effect of preventing total internal reflection can be achieved.

As shown in FIG. 3(b), it is possible to design the height of the guide electrode 32 formed on the inner surface 26 of the optical fiber guide 20. For example, the distance from the outer surface 21 to the bottom surface 28 may be the first height H1. In this case, the inner surface 26 where the guide electrode 32 is installed may have a second height H2 for the part excluding the guide electrode 32, and a third height H3 for the guide electrode 32. Here, the first height H1 can be equal to the sum of the second height H2 and the third height H3. When the guide electrode 32 is formed through deposition processes or similar methods, the third height H3 may be negligible. However, if the third height H3 of the guide electrode 32 increases for reasons such as reinforcement of strength and/or changes in the manufacturing process, the sum of the second and third heights H2, H3 can be designed to be equal to the first height H1 to ensure that the optical fiber guide 20 is coupled parallel to the upper surface of the optical device 40.

As shown in FIG. 3(c), the cross-sectional shape of the coupling hole 22 may vary. For example, the inlet side may have a first width W1, and the outlet side may have a second width W2. The first width W1 can be greater than the second width W2. The first width W1 may correspond to the width of the transmission cable 400 that is coupled into the coupling hole 22. The second width W2 may correspond to the optical fiber 420 after the sheath 410 of the transmission cable 400 is removed. By accommodating the entire transmission cable 400, including the sheath 410, within the first width W1 region, the transmission cable 400 can be more securely coupled to the optical fiber guide 20.

As shown in FIG. 3(d), the inner surface 26 of the optical fiber guide 20 may be composed of the inclined surface 25. In other words, this means that the inclined surface 25 can be formed directly at the point where the coupling surface 23 ends, without the flat surface 24. This configuration can be applied in design situations where sufficient length in the Z-direction of the optical fiber guide 20 is not available.

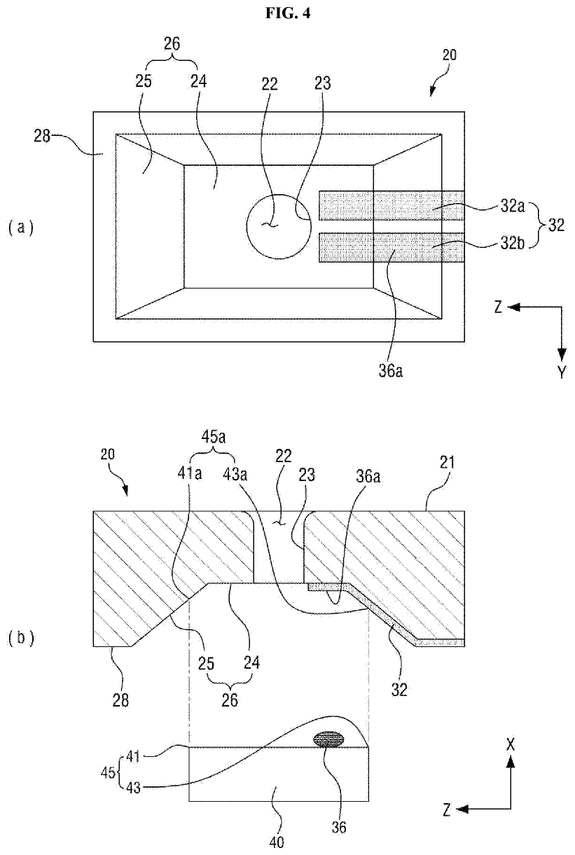

FIG. 4 is a drawing showing the optical fiber guide and the optical device as depicted in FIG. 2.

As shown in FIG. 4, the optical fiber guide 20 and the optical device 40 according to one embodiment of the present invention can be in contact with each other and be coupled.

FIG. 4(a) is a drawing showing the shape of the optical fiber guide 20 in the Z-Y plane. As shown, the coupling hole 22 is formed at the center of the optical fiber guide 20, and the inner surface 26, which includes a flat surface 24 and an inclined surface 25 around the coupling hole 22, may be present. Following the inner surface 26, a bottom surface 28 may be located along the outer perimeter.

The guide electrode 32 may be positioned on a portion of the inner surface 26. For example, it may take the form of a strip extending from one side of the coupling hole 22, across the inner surface 26, down to the bottom surface 28.

The guide electrode 32 can include a first guide electrode 32a and a second guide electrode 32b. For instance, the first guide electrode 32a could be the anode, and the second guide electrode 32b could be the cathode. In this case, two solder balls 36 may be positioned to correspond to the first and second guide electrodes 32a and 32b, respectively.

As shown in FIG. 4(b), the optical fiber guide 20 can be coupled to the optical device 40 in the −X direction. The optical fiber guide 20 may be in contact with the edge 45 of the optical device 40. In other words, the contact portion 45 of the inclined surface 25 of the optical fiber guide 20 can be in contact with the upper edge 45 of the optical device 40. Alternatively, it can be stated that the first and second contact portions 41a and 43a of the inclined surface 25 are in contact with the corresponding first and second edges 41 and 43 of the optical device 40. Put differently, the first and second contact portions 41a and 43a can be supported by the first and second edges 41 and 43. When the first and second contact portions 41a and 43a are in contact with the first and second edges 41 and 43, the solder ball 36 can touch the contact surface 36a of the guide electrode 32. As the first and second contact portions 41a and 43a are in contact with and engage with the first and second edges 41 and 43, the center of the optical device 40 can naturally align with the center of the coupling hole 22.

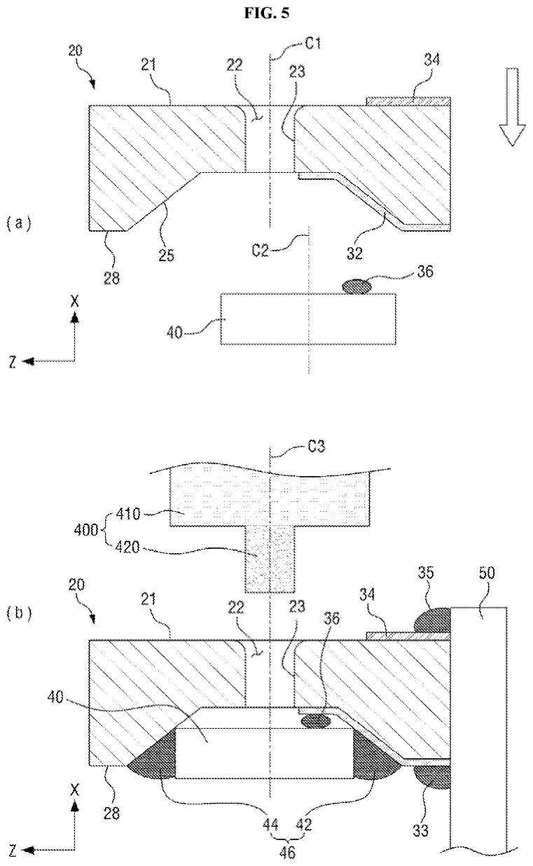

FIG. 5 is a drawing illustrating the coupling relationship between the optical fiber guide and the optical device shown in FIG. 4.

As shown in FIG. 5, the optical fiber guide 20 and the optical device 40 can naturally be coupled, aligning their central axes.

As illustrated in FIG. 5(a), before assembly, the first central axis C1 of the optical fiber guide 20 and the second central axis C2 of the optical device 40 may not align.

The first central axis C1 can refer to the centerline of the optical fiber 420 that will be inserted into the coupling hole 22. In other words, it may represent the path with the highest light transmission efficiency.

The second central axis C2 can refer to the centerline of the optical device 40. This means it could be the path with the highest light transmission efficiency when transmitting or receiving light.

If the first and second central axes C1 and C2 do not align or are tilted, the light transmission efficiency from the optical fiber 420 to the optical device 40, or vice versa, may decrease due to reflection, refraction, or other factors on the surfaces. Therefore, aligning the first and second central axes C1 and C2 is a critical factor for system performance. Traditionally, active alignment processes, which are costly and time-consuming, have been applied for this purpose.

According to one embodiment of the present invention, the first and second central axes C1 and C2 can be naturally aligned. Specifically, when the optical fiber guide 20 is moved in the −X direction to be in contact with the optical device 40, the position of the optical device 40 can shift in the Z or −Z direction along the inclined surface 25. The optical device 40, moving in the Z or −Z direction, will come into contact with two points on the inclined surface 25 and stop at a point where it balances with the coupling force in the −X direction.

As illustrated in FIG. 5(b), when the optical device stops at the point where it balances with the coupling force, the first and second central axes C1 and C2 become aligned, forming a third central axis C3. Once the third central axis C3 is formed and aligned, an adhesive 46 can be applied to secure the position. By coupling the optical fiber 420 of the transmission cable 400 along the third central axis C3, the optical fiber 420 can naturally be positioned at a point where optical transmission efficiency is maximized.

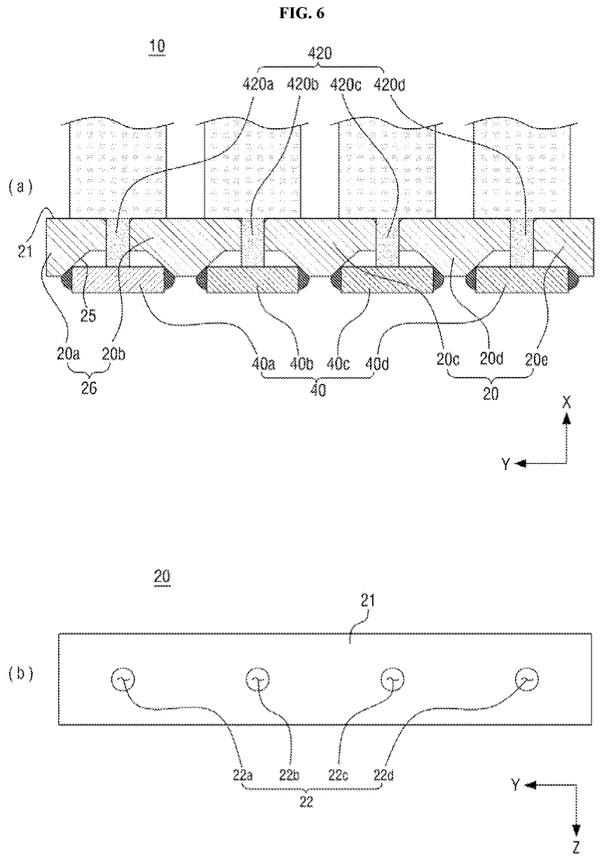

FIG. 6 is a drawing illustrating an optical connector module according to another embodiment of the present invention.

As shown in FIG. 6, the optical connector module 10 according to another embodiment of the present invention can have multiple optical devices 40 coupled to a single optical fiber guide 20.

As illustrated in FIGS. 6(a) and (b), the optical fiber guide 20 may include first to fourth coupling holes 22a to 22d. The first to fourth coupling holes 22a to 22d can accommodate first to fourth optical fibers 420a to 420d. The first to fourth optical fibers 420a to 420d can correspond to the first to fourth optical devices 40a to 40d.

When distinguishing the optical fiber guide 20 into first to fourth optical fiber guides 20a to 20d, centered around the first to fourth coupling holes 22a to 22d, at least one of the first to fifth optical fiber guides 20a to 20e may have a different shape from at least one of the others. For example, the first and fifth optical fiber guides 20a and 20e, located on the outermost sides, may have a different shape from the second, third, and fourth optical fiber guides 20b, 20c, and 20d, located on the inner sides. The ability to vary the shape of the optical fiber guide 20 allows for greater design flexibility.

The optical fiber guide 20 according to one embodiment of the present invention can achieve natural alignment even when multiple optical devices 40 are coupled, thereby ensuring higher productivity.

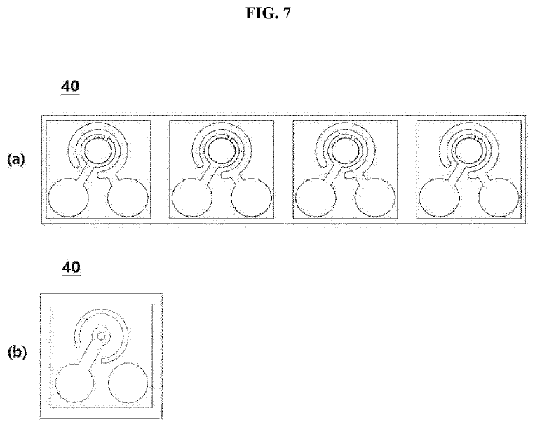

FIG. 7 is a drawing illustrating an optical device according to one embodiment of the present invention.

As illustrated in FIG. 7, the optical device 40 according to one embodiment of the present invention can be arranged either as a single unit or in multiple units depending on the number of required optical elements.

As illustrated in FIG. 7(a), the optical device 40 may be in a configuration where multiple optical elements are arranged. For example, as shown, it can mean that four optical elements are integrated and arranged in a line. This implies that multiple light-emitting elements, multiple light-receiving elements, or a combination of light-emitting and light-receiving elements can be arranged. Such a configuration can be described as a 4-channel arrangement and may be continuously arranged in 8-channel, 16-channel formats as needed. When continuously arranged, the edges of the optical device 40 on both sides can be guided by the inclined surface 25 and positioned in the designed correct location.

As illustrated in FIG. 7(b), the optical device 40 may be in a configuration with a single optical element arranged. This means it can be an optical device 40 composed of a single light-emitting element or a light-receiving element. An optical device 40 composed of a single optical element can have its edges guided by the inclined surface 25, placing it in the designed correct position.

The detailed description provided above should not be construed as limiting in all aspects but rather should be considered illustrative. The scope of the present invention should be determined by the reasonable interpretation of the appended claims, and all modifications within the equivalent scope of the present invention are included in the scope of the invention.

1. An optical connector module, comprising:
at least one optical device configured to include at least one of a light-emitting device and a light-receiving device; and
an optical fiber guide configured to contact the optical device on at least two points to align a first optical path of the optical device with a second optical path of the optical fiber at a predetermined position, wherein the second optical path acquires light generated by the optical device or transmits light to the optical device.

2. The optical connector module of claim 1, wherein the optical fiber guide includes:
an outer surface,
a coupling surface that perpendicularly penetrates the outer surface and forms a coupling hole for accommodating the optical fiber, and
an inner surface extending from the coupling surface, with at least one region extending in a slanted manner so as not to be parallel to the outer surface and the coupling surface,
wherein the optical fiber guide contacts the optical device on at least two points with a slanted region of the inner surface to align the first and second optical paths with each other.

3. The optical connector module of claim 2, wherein the at least two points are located at a first corner of the optical device and at another first corner symmetrical to the first corner about the center of the optical device.

4. The optical connector module of claim 1, further comprising:
a guide electrode formed on at least a portion of an inner surface that contacts the optical device, for connecting and transmitting electrical signals between the optical device and the main substrate.

5. The optical connector module of claim 4, further comprising:
at least one solder ball positioned between the guide electrode and the optical device, wherein the at least one solder ball is deformed by at least one of heat and pressure when the optical fiber guide contacts the optical device, to connect the guide electrode with an electrode of the optical device.

6. The optical connector module of claim 4, further comprising:
a reinforcement plate formed on the outer surface of the optical guide corresponding to the inner surface where the guide electrode is formed,
wherein the optical guide is coupled to the main board in a direction perpendicular to the main board while the guide electrode and the reinforcement plate are soldered to the main board.

7. The optical connector module of claim 1, wherein the first and second optical paths are virtual paths formed along the center lines of the optical device and the optical fiber, representing highest light transmission efficiency between the optical device and the optical fiber.

8. An optical interconnection module, comprising:
a substrate;
a control device mounted on the substrate; and
an optical connector module mounted on the substrate to generate or receive optical signals according to control signals from the control device,
wherein the optical connector module comprises:
at least one optical device configured to include at least one of a light-emitting device and a light-receiving device; and
an optical fiber guide configured to contact the optical device on at least two points to align a first optical path of the optical device with a second optical path of the optical fiber at a predetermined position, wherein the second optical path acquires light generated by the optical device or transmits light to the optical device.
